(19) United States
(12) Patent Application Publication
(10) Pub. No.: US 2011/0266904 A1
(43) Pub. Date: Nov. 3, 2011

(54) PERMANENT MAGNET ACTUATOR FOR ADAPTIVE ACTUATION

(76) Inventors: Cesare Stefanini, Vicopisano (IT); Stefano Mintchev, Pisa (IT); Paolo Dario, Livomo (IT)

(21) Appl. No.: 13/056,972

(22) PCT Filed: Aug. 4, 2009
(86) PCT No.: PCT/IB09/53376

§ 371 Date: Mar. 17, 2011

(30) Foreign Application Priority Data
Aug. 4, 2008 (IT) FI2008A000150

(51) Int. Cl. H02K 21/02; H01F 7/02

(52) U.S. Cl. 310/152; 335/306

(57) ABSTRACT

A magnetic actuator for adaptive type actuation comprising a set of permanent magnets (M) including at least one first set of magnets and one second set of magnets spatially arranged so as to be able to interact magnetically with one another; means (SM) for orienting the magnets of one set in relation to the magnets of the other set in order to vary the mutual interaction between them; potential energy storage means (RE) connected to the two sets of magnets to recover the energy needed to orient the magnets.

### FIELD OF THE INVENTION

The present invention relates to a magnetic actuator with permanent magnets particularly for adaptive actuation.

### STATE OF THE ART

The commercially-available actuators commonly used in a great variety of technical fields are those of electromagnetic type, where power is obtained from interactions between currents circulating in the conductors and the magnetic field. The characteristics of the three main types of actuation that exploit commercially-available motors are as follows:
Direct actuation. This category includes two types of actuator based on different physical principles:
   Lorentz force. Classic motors for direct use, i.e. without the aid of gearmotors. The advantages are complete reversibility and the opportunity to obtain a force as a primary output effect, at the expense of efficiency (that is typically very low) and of the force that, once the dimensions of the actuator have been set, is weak.
   Variable reluctance. The presence of a solenoid with a current running through it enables the formation of a magnetic flow circulating in a suitable circuit made of ferromagnetic material. Attraction forces usable for actuation are generated at air gaps. The need to ensure forces consistent with the increase in the air gap demands intense currents resulting in dissipations due to the Joule effect and low efficiencies.
Actuation with gearmotors. In this case a gearmotor is connected to the motor. This enables efficiency to be improved at the expense of the system reversibility. In addition, the primary output effect is a displacement (rotation) and a force is obtained only as an indirect consequence.
Hydraulic or pneumatic actuation. The motor (possibly associated with a gearmotor) is used to increase the pressure of a fluid that enables the movement of the hydraulic actuators. This ensures the recovery of some degree of reversibility and of the capacity to control rigidity, and the opportunity to obtain forces as output. However, as compared to the previous actuation system, the presence of a fluid circuit entails a greater weight and overall dimensions causing trouble to the movement. The fluid circuit and the need to introduce drive machines to energize the fluid give rise to a considerable reduction in performance by comparison with the motor-gearmotor combination.

Among the actuators there are three groups based on magnetic interactions exploiting the Laplace-Lorentz forces, i.e. the forces produced by reluctance variations.
Actuators with mobile windings. When the winding is placed in a static magnetic field and a current runs through it, it is subject to the Laplace-Lorentz force. This is proportional to the current and the actuator is easy to control (loudspeakers are a typical example).
Actuators with mobile magnets. A permanent magnet placed between two poles can be shifted from one to the other, energizing a solenoid. This type of actuator enables high forces to be obtained, but it is bistable and consequently difficult to control.
Actuators with mobile ferromagnetic elements. A ferromagnetic element is placed in a system with windings. When a current is passed through the windings, the ferromagnetic element moves naturally so as to minimize the energy in the system.

As regards the technical applications of permanent magnets, it is worth noting that their use has increased mainly thanks to recent developments in manufacturing methods and the consequent opportunity to produce increasingly powerful magnets without increasing their weight and size.

Permanent magnets are currently used mainly in two ways in the field of actuation:
to generate permanent magnetic fields. The capacity of permanent magnets to generate fields is exploited in combination with conductors through which a current is passed. This enables the Lorentz forces or the forces due to the variable reluctance to be generated;
to transmit forces remotely. This property is typically not exploited in the field of actuation, but it is used in the case of switching devices or magnetic couplings.

Another characteristic property of magnets is their capacity to mutually interact through attraction and repulsion forces, depending on their orientation. The typical applications of this property are magnetic bearings or Maglev, where forces of repulsion are used to separate components in order to reduce friction.

This property might be considered for use in the field of actuation, where the nature of direct magnetic interactions enables some of the drawbacks of traditional actuators to be overcome.

An example of the application of magnetic levitation to actuation and to the exploitation of forces in robotics is described in Masahiro Tsuda et al., “Magnetic Levitation Servo for Flexible Assembly Automation”, International Journal of Robotics Research, Vol. 11, No. 4, 329-345 (1992). The problem discussed here is that of the adaptability of robotic manipulators, which is solved by combining electromagnetic actuators with a suitable control system. In this case, however, traditional electromagnets are used with a consequently limited efficiency and low forces available.

DE2513001 describes a magnetic actuator comprising two sets of permanent magnets spatially arranged so as to be able to interact with one another, and means for orienting the magnets of one set in relation to the magnets of the other in order to vary the force of mutual magnetic interaction. The actuator comprises means for storing potential energy, in the form of magnetic discs or spiral springs, connected to both sets of magnets in order to recover the energy needed to orient the magnets. This actuator is not suitable for use in the creation of adaptive-type robotic systems.

WO2004064238 describes the opportunity to use the direct interaction of magnets, which is variable according to the orientation of a control magnet, to move an object carrying a permanent magnet forwards and backwards. A magnet rotating on one side of the object alternately faces the N or S polarity towards it, and exerts alternating attraction and repulsion forces on the object that make the object move forwards and backwards.

In JP2007104817 and JP2008054374, there is an energy recovery in the phase of magnet orientation by means of a disc on which counterweights are keyed, but this solution has the drawback of not permitting the creation of miniature objects due to scale effects. The forces deriving from the magnetic interactions are proportional to the surface, while those of the balancing system are proportional to the mass and hence to the volume. Moreover, the system proposed in this patent enables the actuator to function only in static conditions, with no changes in gravity, making it unsuitable for mobile applications as, for instance, in the field of robotics.

WO01/69613 describes an actuator with permanent magnets that uses a repulsive magnetic force for actuation. The actuator mechanism comprises a first translator member with a permanent magnet displaceable between two positions, and a second translator member with another permanent magnet displaceable between two positions, the two magnets being mutually repulsive. A containment structure limits the stroke of the two translator members. When one of the two translator members is moved in one direction, the other moves in the opposite direction, the displacement process being reversible. There is a partial energy recovery by elastic means. The system is of the bistable type and is consequently not adaptable and it does not permit any modulation of the output force.

Until now, the actuators used in robotics, and in the field of bio-inspired robotics in particular, have been featured by efficiencies very far from those achieved, for instance, by muscles. The principal limitations concern inertia, irreversibility, a low energy efficiency and the inability to control rigidity. In applications where a natural, or at least adaptive, type of interaction is required, with the environment and with the user, these limitations of the known actuators prevent the development of suitable machines and oblige the user to correct unwanted effects by means of dedicated and only partially effective control methods.

### SCOPE AND SUMMARY OF THE INVENTION

The object of the present invention is to provide a magnetic actuator with permanent magnets that has a high efficiency and is capable of providing high forces characterized by a marked adaptability, i.e. reversibility and rigidity control, in relation to the outside environment and the user.

Another object of the present invention is to provide an actuator with permanent magnets of the above-mentioned type in which it is possible to manage the magnetic field with ease to concentrate and convey the field generated by the magnets in a generic position in space, facilitating their correct interaction.

A further object of the present invention is to provide a magnetic actuator of the above-mentioned type that is suitable for applications in the field of bio-inspired robotics.

These objects are achieved by the actuator with permanent magnets according to the present invention, the essential characteristics of which are set forth in claim 1. Further important characteristics are set forth in the dependent claims.

The magnetic actuator according to the invention generally comprises a set of permanent magnets comprising at least one first set of magnets and one second set of magnets spatially arranged so as to be able to interact magnetically with one another; means for orienting the magnets in one set in relation to the magnets in the other set in order to vary the mutual interaction between them; means for storing the potential energy connected to one or more sets of magnets to recover the energy needed to orient the magnets; and elastic means interposed between the magnets to regulate the delivery of the force resulting from said interaction.

According to one aspect of the invention, the actuator is used to create a robotic element and the mutual attraction and repulsion actions are exploited to induce the flexion of the single segments forming the structure of the robot, reproducing a typically snake-like movement.

In a preferred embodiment, the flexional actuation is obtained by providing at least one first set of magnets and at least one second set of magnets, each comprising at least one pair of diametrically magnetized permanent magnets integral with one another, said pairs of permanent magnets lying on respective parallel planes, when no mutual interactions are present, and with their respective magnets aligned in two rows. Each pair is associated with drive means for varying the orientation of at least one of the two magnets in the pair, the magnets of each pair being connected together by the potential energy storage means, and flexible connection means being provided between the two consecutive pairs in the direction of alignment of the magnets, so as to enable flexion and to produce an elastic reaction that regulates the interaction forces.

According to another aspect of the invention, the actuator is used in a linear configuration. A possible use concerns the “muscle-like” actuation systems, by means of which the properties of muscles, and particularly the capacity to generate force, adaptability, relaxation and tone, can be reproduced.

In a preferred embodiment of linear actuation the magnets forming a first set of magnets and a second set of magnets are diametrically magnetized, substantially cylindrical bodies aligned along their central axis and parallel to one another, the magnets of the first set alternating in said axial alignment with those of the second set. The actuator also comprises drive means connected to the magnets of at least one of the two sets for varying the relative orientation so as to pass from a configuration of mutual attraction between the magnets of the first and second sets to a configuration of mutual repulsion, and vice versa, the potential energy storage means taking effect on the rotation of the sets of magnets. To regulate the magnetic interaction force, elastic means are provided between the two consecutive magnets of two sets of magnets.

The magnetic actuator according to the invention has the following functions:
direct interaction between permanent magnets;
control of the magnetic forces: modifying the mutual orientation of the permanent magnets enables the intensity and direction of the interaction forces to be controlled, and using means for elastically regulating the force makes it possible to modify the response of the system for the same orientation of the magnets, e.g. to achieve functional stability;
energy recovery: recovering the energy needed to vary the orientation of the magnets means that only the energy effectively useful for actuation is needed.

The resulting properties are as follows:
a force as output
forces of high intensity
adaptability
high efficiency
stability

The permanent magnets actuator according to the present invention thus enables the exploitation of the attraction and repulsion forces that are transmitted remotely through the generated magnetic field. The intensity (which may even have a very high maximum value, thanks to the use of magnets with a great residual induction) and the direction of the mutual actions can be controlled by modifying the orientation of the magnets. It is also possible to achieve reversibility, and the conservative nature of the interactions between the magnets ensures a high performance to be achieved.

### BRIEF DESCRIPTION OF THE DRAWINGS

Further characteristics and advantages of the actuator with permanent magnets according to the present invention will be apparent from the following description of embodiments thereof, given here as a non-limiting examples with reference to the attached drawings, wherein:

FIG. 1 shows a schematic diagram of the actuator with permanent magnets according to the present invention in a configuration designed to produce a force as output;

FIG. 2 shows a schematic diagram of the actuator with permanent magnets according to the present invention in a configuration designed to produce a torque as output (bending moment);

FIGS. 3a, 3b, 3c shows the operating principle of the actuator according to the invention and FIG. 3d shows the effect on the repulsive force of several magnetic modules involved in the actuation;

FIG. 4 shows a way of controlling the intensity of the forces generated in the actuator according to the invention;

FIG. 5a), b), c) shows a schematic diagram of energy recovery in the actuator according to the invention;

FIG. 6a), b), c) shows a schematic diagram of the regulating system in the actuator according to the invention;

FIG. 7a), b) shows a first embodiment of a flexional actuator according to the invention in a (a) neutral and (b) attractive configuration;

FIGS. 8a, 8b, 8c show a flexional actuator module according to the invention;

FIG. 9 shows the operating principle of a second embodiment of the actuator according to the invention in a linear (a) attractive and (b) repulsive configuration;

FIGS. 10a and 10b show a perspective view of a linear actuator according to the invention in two different operating conditions;

FIG. 11 shows a longitudinal section of the actuator of FIG. 10;

FIG. 12 is an exploded perspective, cross-sectional view of the actuator of FIG. 10;

FIG. 13 is an exploded, enlarged view of a detail of the linear actuator of FIG. 10;

FIG. 14 is a perspective front view of the drive outlets from the gearmotor for the linear actuator of FIG. 10;

FIG. 15 shows an example of an elastic element that takes effect between two consecutive magnets;

FIG. 16a, b, c shows the modulation of the output force with the aid of the elastic elements;

FIG. 17a), b) shows a second embodiment of a linear actuator according to the invention respectively in the neutral and active conditions.

### DETAILED DESCRIPTION OF THE INVENTION

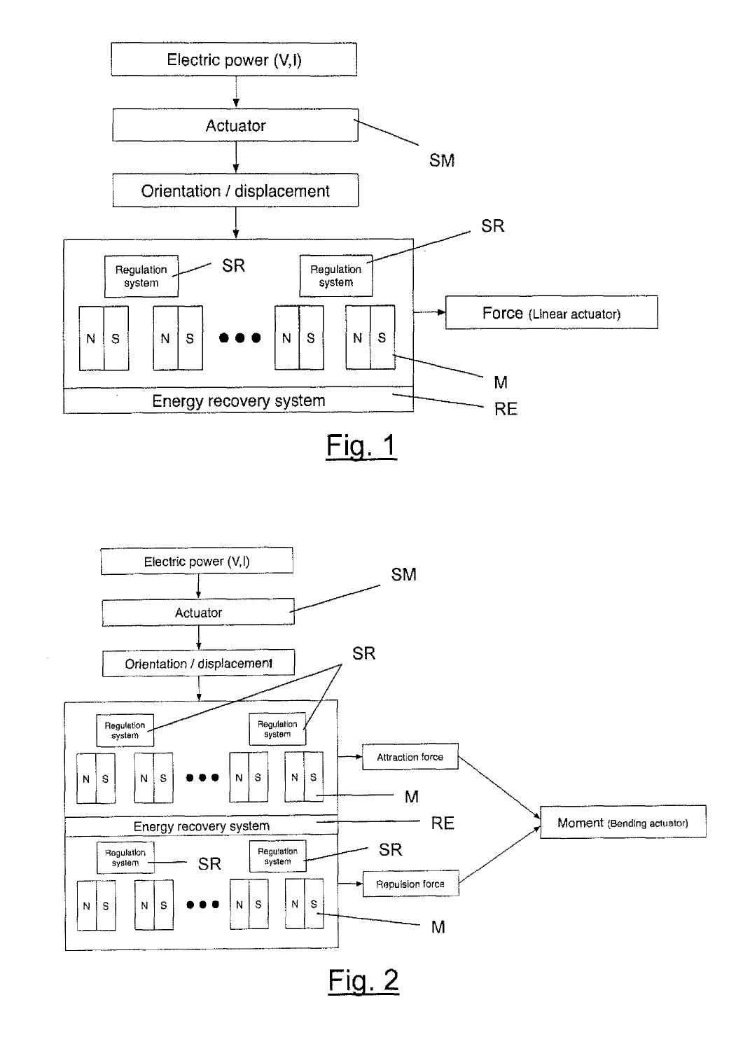

FIGS. 1 and 2 show a schematic diagram of the actuator according to the invention and its component parts: a set of magnets M that can occupy various spatial configurations provided that they are submitted to mutual interactions; a servo-assisted motor SM for selectively orienting the magnets and modify the mutual interactions and, as a consequence, the intensity and direction of the magnetic interactions; an energy recovery system RE that, by exploiting the conservative nature of the magnetic interactions, enables the recovery of the energy needed for the orientation of the magnets. The energy recovery system RE advantageously consists of elastic elements that enable the achievement of an effective balancing of the magnets, thus allowing for a potential miniaturization of the actuator and its use in dynamic applications; a regulating system SR comprising further elastic means. The actuator produces a force as output and can be used both in a linear (FIG. 1) and in a flexional (FIG. 2) configuration. In the latter case it is convenient to exploit two sets of magnets that interact alternately or in opposition to one another.

In addition to the above-listed elements needed for the operation of the actuator, there may advantageously be additional elements made of a ferromagnetic material that enable the magnetic interaction to be controlled more effectively, enabling the field generated by the magnets to be concentrated and carried in space. This can be useful to maximize the magnetic interaction and therefore the mutual attractive or repulsive forces, or to minimize it so as to obtain neutral configurations of non-interaction in which the field of the magnet is enclosed inside the magnet. The example of a flexional actuator shown in the present invention has a balanced configuration that is obtained by exploiting this specific property. The opportunity to isolate the magnets according to their configuration enables stable actuators to be obtained, and not bistable actuators as in the known art. This enables a better control of the actuator.

The further elastic means form the regulating system SR indicated in FIGS. 1 and 2. The presence of these elastic elements, like the elastic means for storing potential energy, serves the purpose of balancing the magnetic forces by means of the reaction forces due to the deformation. With the elastic means for storing the potential energy, however, this balancing effect serves to reduce the force needed to mutually orient the magnets, thus limiting the energy consumption for the actuation of the system. Instead, the elastic means forming the regulating system SR modify the resultant force of attraction or repulsion, so as to obtain “force-displacement” characteristics suited to various applications. In both cases, the use of elastic means guarantees the preservation of the energy and the achievement of a high overall actuation efficiency. The use of this property will be analyzed in more detail in the example of a linear actuator.

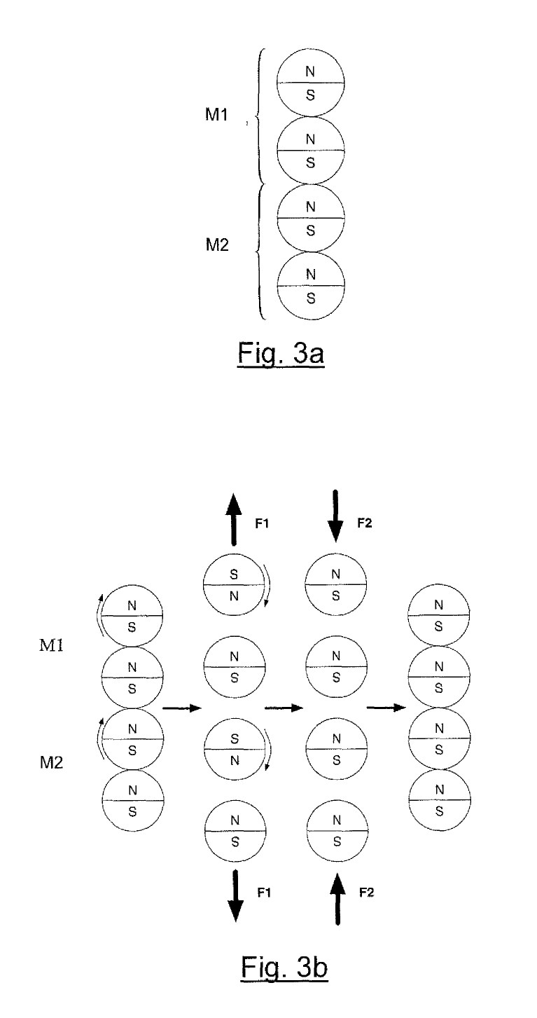

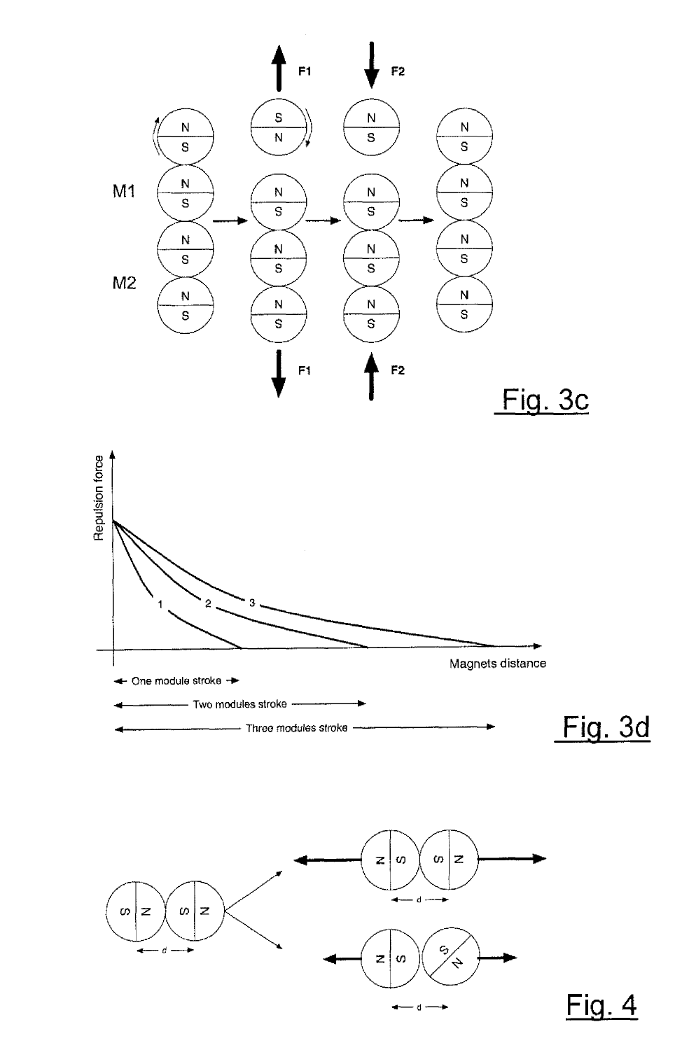

The operating principle of the actuator with permanent magnets according to the present invention can be explained considering a set of diametrically magnetized circular magnets aligned on the same plane. In the present description, the term “diametrically magnetized” is used to mean that the body forming the magnet has a substantially circular cross section, particularly of cylindrical or discoid shape, and a given diameter that divides said body into two sectors with opposite magnetic polarities. FIG. 3a schematically shows a generic linear actuator according to the invention comprising two magnetic modules M1 and M2 arranged as explained above. The fundamental idea consists in modifying the magnetic configuration of the single modules so as to vary their mutual actions. The variation may affect all the magnetic modules or only a partial succession of them. Suppose, for instance, that the initial configuration involves the presence of the magnets positioned with an alternating orientation, i.e. in the attracting configuration, as shown in FIG. 3a. If we want to take action on all the magnetic modules (FIG. 3b), the non-adjacent magnets of each module are rotated through 180° with the aid of a conventional actuator, switching to a repulsive configuration, so that the magnets tend to move apart, producing repulsive forces F1. If the same magnets are rotated through 180° again to return to the initial configuration, attraction forces F2 are obtained. In the second case (FIG. 3c) the operation is similar, but only one module is involved in the change of orientation, e.g. the module M1, obtaining an equivalent effect.

FIG. 3d shows the trend of the repulsive force as a function of the stroke of the actuator when the number of magnetic modules involved in the actuation is varied. As shown in the figure, the increase in the modules produces an increase in the maximum stroke of the actuator. In addition, being a configuration consisting of modules arranged in series, the maximum and minimum forces retain the same value irrespective of the number of active segments. This prompts a modification in the force-displacement characteristic as the number of active modules is varied.

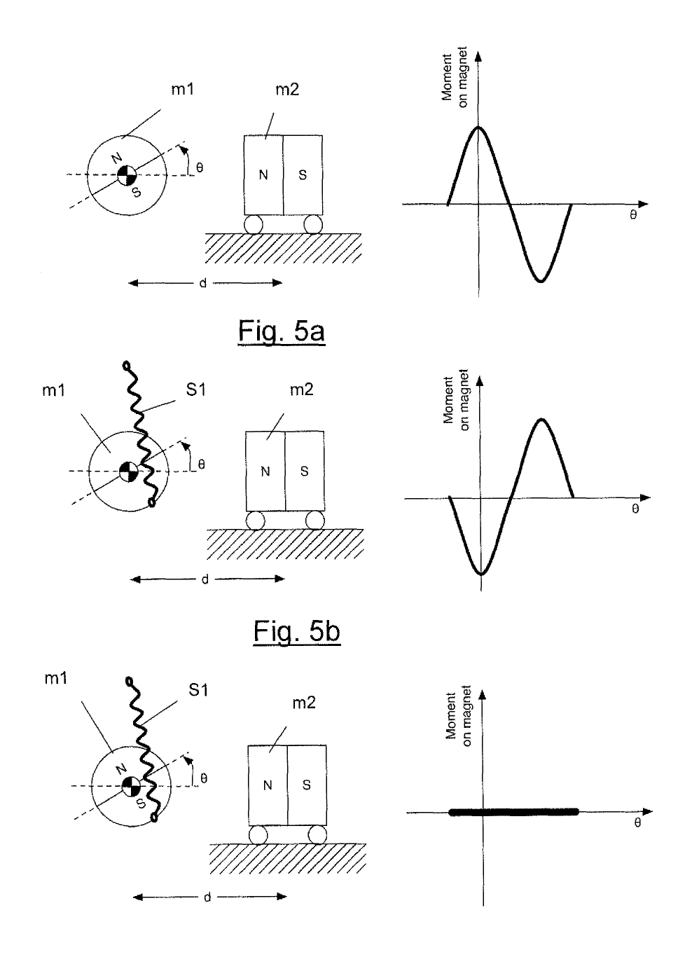

FIG. 4 shows the control of the intensity of the forces by means of a modification of the orientation of the magnets. Having established a certain distance “d” between two magnets, the exchanged force can be varied by controlling the rotation of the magnets. The maximum attraction or repulsion forces can be very strong if magnets with a high residual induction (such as neodymium magnets) are used.

The energy recovery system ensures the balancing of the magnets during their rotation in the passage between the two main configurations, i.e. attraction and repulsion configurations. This means that only the useful energy needed for the translation of the magnets has to be delivered. The energy recovery system can be achieved with a generic potential energy storage system; for instance, a system with elastic elements enables an exchange between potential magnetic energy and potential elastic energy. Typically the implementation of the energy recovery system is simplified by the trend of the rotational torque of the magnets, which is roughly of sinusoidal type. An example is given in FIG. 5a), b), c) in the graphs that represent the trend of the torque on the magnets. In this case, there are two magnets m1 and m2: the rotation of the first magnet m1 enables the translation of the second magnet m2. Since the distance “d” between the two magnets is fixed, the energy recovery system enables the rotation of the first magnet m1 to be balanced with the aid of an elastic element S1. The first graph (FIG. 5a) shows the trend of the magnetic moment needed for the rotation of the first magnet m1, while the second graph (FIG. 5b) shows the elastic moment that is equal and in opposition to the former one, and that enables the rotation of the first magnet to be balanced, if the distance between the magnets is the same (FIG. 5c).

Other potential energy recovery systems may consist of other magnets in mutual interaction, or variable-volume chambers containing a gas.

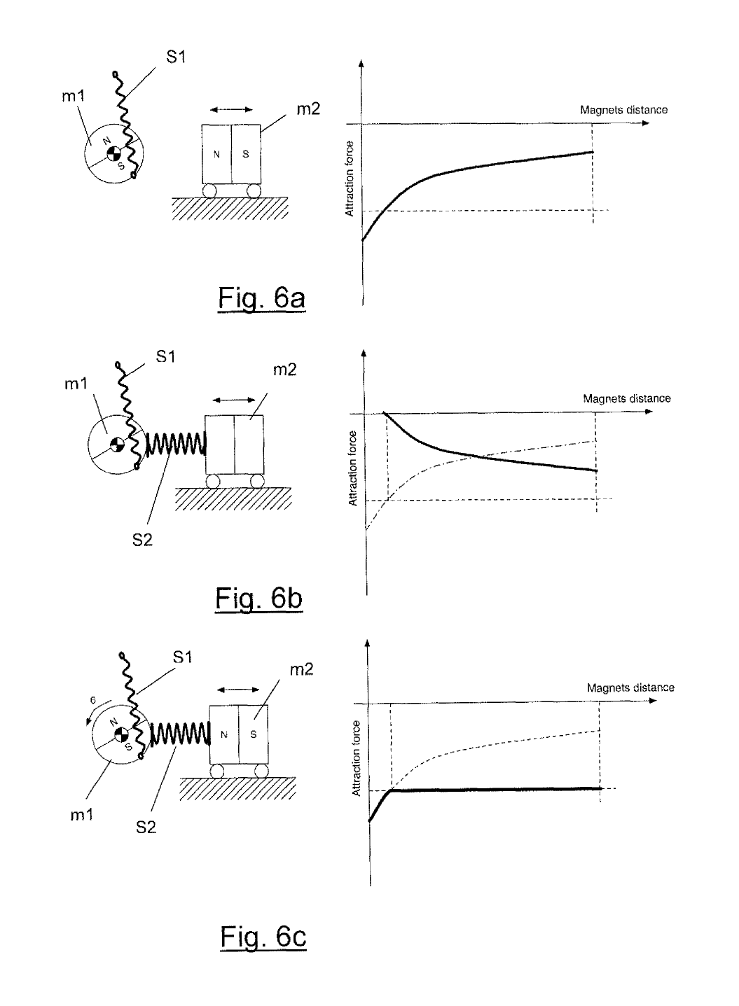

FIG. 6 recalls the content of the previous figure, but with the addition of further elastic means S2 implementing the force regulating system. For the same orientation between the first and second magnets, this system enables the force response of the system to be modified, obtaining a constant output force as the distances between the magnets varies. As mentioned previously, the use of these properties will be analyzed in more detail in the example of a linear actuator.

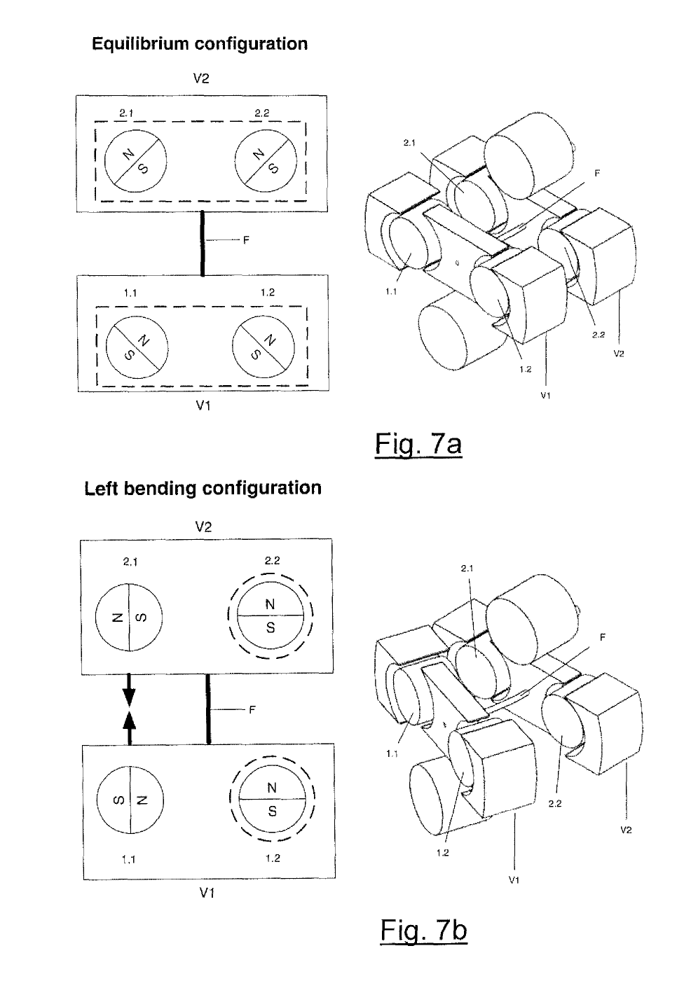

FIG. 7 shows a first embodiment of a magnetic actuator according to the invention, developed particularly for a bio-inspired aquatic robot capable of an undulating swimming action. The mutual attraction and repulsion actions enable the flexing of single segments or modules that constitute the structure of the robot, reproducing a typically snake-like movement.

The robot comprises a flexible central filament F to which a set of modules (vertebrae) V1, V2 are keyed. The filament F thus serves as a connection between two adjacent modules and, thanks to its flexibility, it also has the function of regulating the interaction forces between two consecutive modules.

In this case the set of magnets in the actuator is formed of pairs of permanent magnets, two of which are identified as 1.1, 1.2 and 2.1, 2.2 in FIG. 7, arranged on parallel planes when the system is in the neutral or balanced configuration. A rotation through 45° of the magnets of two consecutive modules induces a shift from the balanced to the active configuration, in which two aligned magnets of two consecutive pairs change to the attractive condition, inducing the flexion of the robot. The flexible element F that joins the two vertebrae V1 and V2 enables the vertebrae to be restored to a parallel position when, after their flexion, the magnets return to the initial balanced configuration. FIG. 7 shows the arrangement of the magnets in the two main (a) balanced and (b) attractive configurations. The dotted contours around the magnets of each vertebra, containing material with a high magnetic permeability, indicate that the field generated by the magnets is enclosed inside each vertebra in the first configuration, preventing their interaction. In the second configuration the two magnets 1.1 and 2.1 (on the left in the drawing) interact, producing the flexional effect maximized by the polar expansion, while the field lines of the magnets 1.2 and 2.2 (on the right in the drawing) continue to be enclosed inside the vertebra and do not take part to the flexing action.

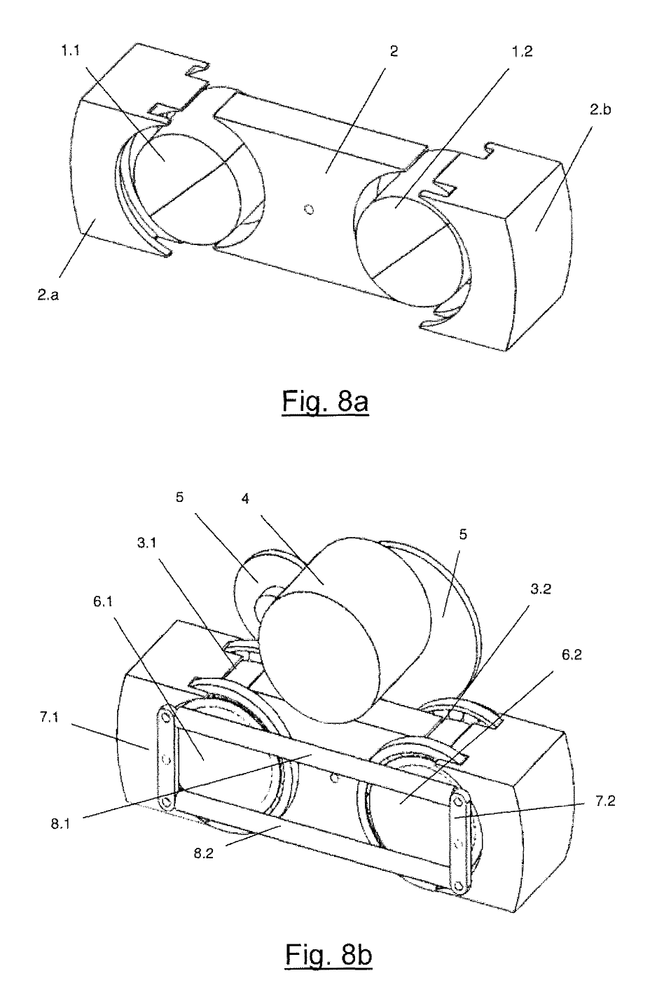

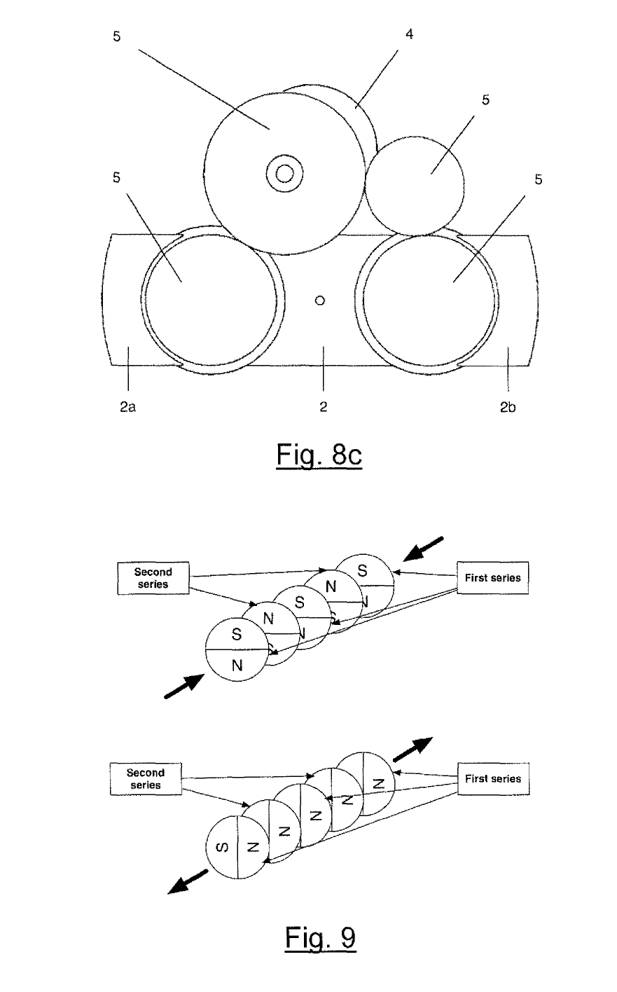

FIG. 8, details a), b) and c), show the module or vertebra of the magnetic actuator in the flexional configuration according to the invention where the previously-described essential components can be seen, with the addition of some elements included in this specific case.

Two diametrically magnetized magnets 1.1 and 1.2, of cylindrical shape, are contained inside a structure made of a ferromagnetic material 2 that makes them integral with one another. The structure 2 facilitates the management of the magnetic field by means of a geometry adopted to surround the two magnets and have two polar expansions 2a, 2b at the ends.

The first characteristic guarantees the enclosure of the field lines within the vertebra in the balanced configuration, enabling its isolation from the other vertebrae, thus enabling a stable actuator to be obtained, unlike the known art.

The second characteristic enables the magnetic field to be concentrated, in the shift to the active configuration, at the ends 2a, 2b of the modules, thereby maximizing the flexional effect.

The two magnets are fitted in bearings 3.1 and 3.2 (FIG. 8b) so as to facilitate their rotation, minimizing any losses due to friction. The bearings are made of a non-ferromagnetic material to prevent them from influencing the field generated by the magnets. A motor 4 complete with an encoder enables the magnets to be rotated and their orientation to be controlled; by so doing, it is possible to modify the intensity of the output force. The movement is transmitted to the two magnets by means of a drive element with toothed wheels 5 that are also made of a non-ferromagnetic material to prevent them from influencing the magnetic field.

The energy recovery system comprises two toothed wheels, or friction wheels or pulleys, 6.1 and 6.2 keyed coaxially onto the two magnets 1.1 and 1.2, two arms 7.1 and 7.2 hinged with their ends to the respective wheels 6.1 and 6.2 and two springs 8.1 and 8.2 connected to the arms and parallel to one another. The two springs are mounted already preloaded and during the rotation of the magnets they become shorter, providing the necessary balancing moment. In this solution, the springs provide a moment of sinusoidal type that is equal and in opposition to that of the magnets, enabling a substantially total energy recovery, except for the friction.

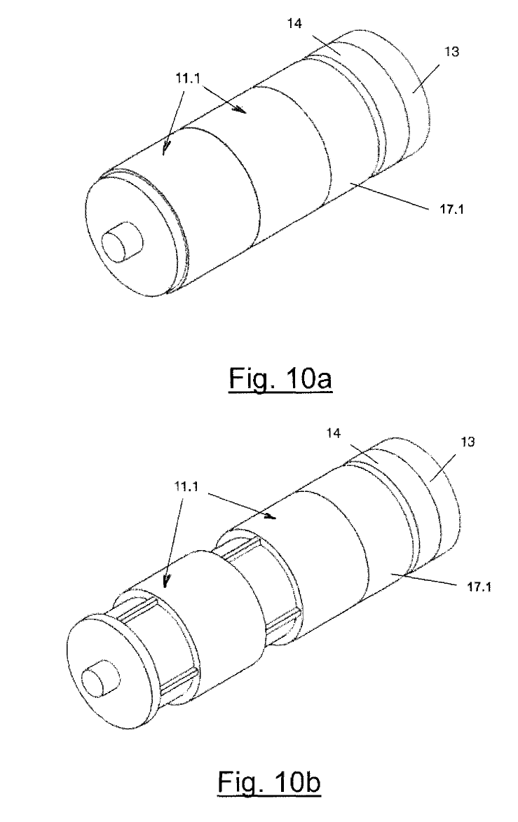

Various magnetic configurations are feasible in the linear configuration of the actuator according to the invention. In the most straightforward embodiment, shown in FIG. 9, the set of magnets consists of substantially circular bodies (and cylindrical or discoid in particular), diametrically magnetized and aligned along their central axis on parallel planes. The counter-rotation of two sets of magnets enables forces of attraction and repulsion to be obtained. FIG. 10 shows the two configurations in conditions of (a) attraction and (b) repulsion.

An example of a linear actuator according to the invention is shown in FIGS. 10a and 10b, where the magnets are respectively in configurations of attraction and repulsion, according to the first of the two previously described configurations.

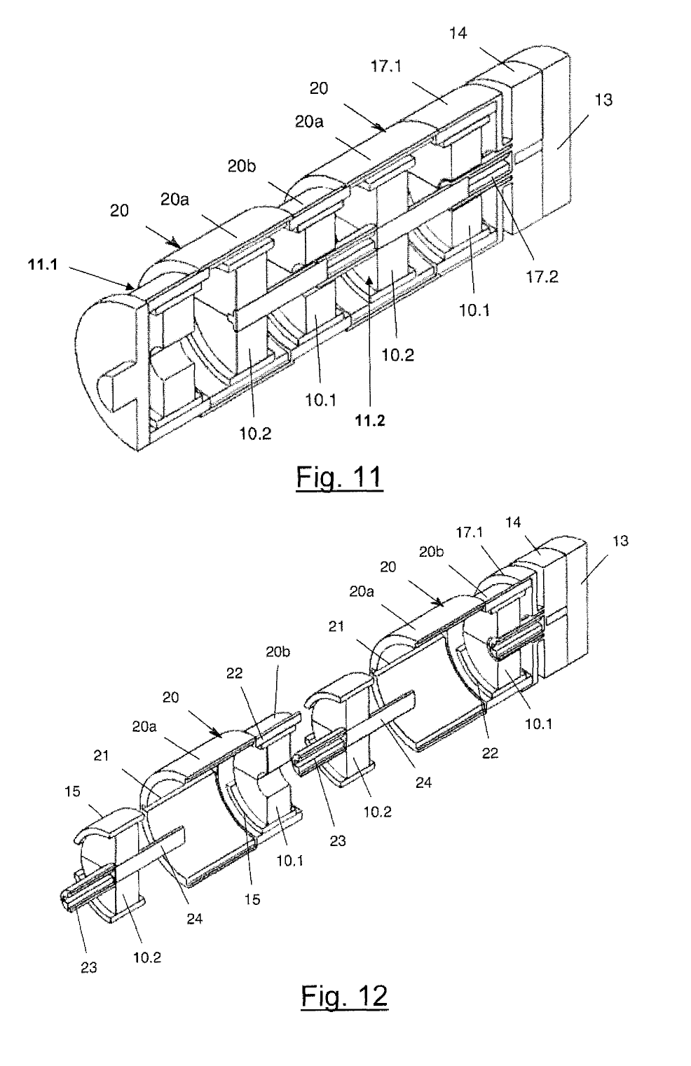

As shown in more detail in FIGS. 11 to 14, the diametrically magnetized cylindrical magnets can be divided into two sets 10.1 and 10.2. The magnets of the first set 10.1 are keyed onto external grooved profiles 11.1 and the magnets of the second 10.2 onto internal grooved profiles 11.2. This assembly enables the mutual rotation and the translation of the two sets of magnets.

More in particular, the external grooved profile 11.1 comprises a tubular body 20 with two coaxial portions 20a and 20b of different diameter, the portion 20b having an outer diameter such that it can engage in the portion 20a of an adjacent tubular body 20. Axial grooves 21 are formed inside the portion of wider diameter, while corresponding axial ribs 22 are formed on the portion of narrower diameter 20b. The magnets of the set 10.1 are fitted inside the portions of narrower diameter 20b of the respective tubular bodies 20. Each magnet of the second set 10.2 is keyed onto a respective internal grooved profile 11.2 formed by a hollow pin 23 extending axially from one side of the magnet and a pin with a cross-shaped cross section 24 extending coaxially from the opposite side of the magnet. The cavity in the pin 23 has the same cross section as that of the pin 24, so that the pin 24 extending from one magnet 10.2 can engage in the cavity in the pin 23 of an adjacent magnet 10.2.

The magnets of the set 10.1 are pivotally mounted on the respective pins 23 of the magnets of the set 10.2.

A motor 13 equipped with an encoder enables the magnets to rotate and their mutual orientation to be controlled. A gearmotor system 14 keyed onto the motor and with two counter-rotating drive outlets 17.1 and 17.2 transmits the motion to the two grooved profiles 11.1 and 11.2. For this purpose, as shown in FIG. 14, the outlet 17.1 of the gearmotor is ring-shaped with an internal diameter substantially equal to the external diameter of the portion 20b and it has internal grooves 25 in which the ribs 22 formed on the portion 20b of a grooved external profile 11.1 engage to enable the transmission of the rotary motion to the set of magnets 10.1. The outlet 17.2 of the gearmotor is a hollow shaft 27 inside which the pin with a cross-shaped cross section 24 of an internal grooved profile 11.2 engages so as to transmit the rotary motion to the set of magnets 10.2.

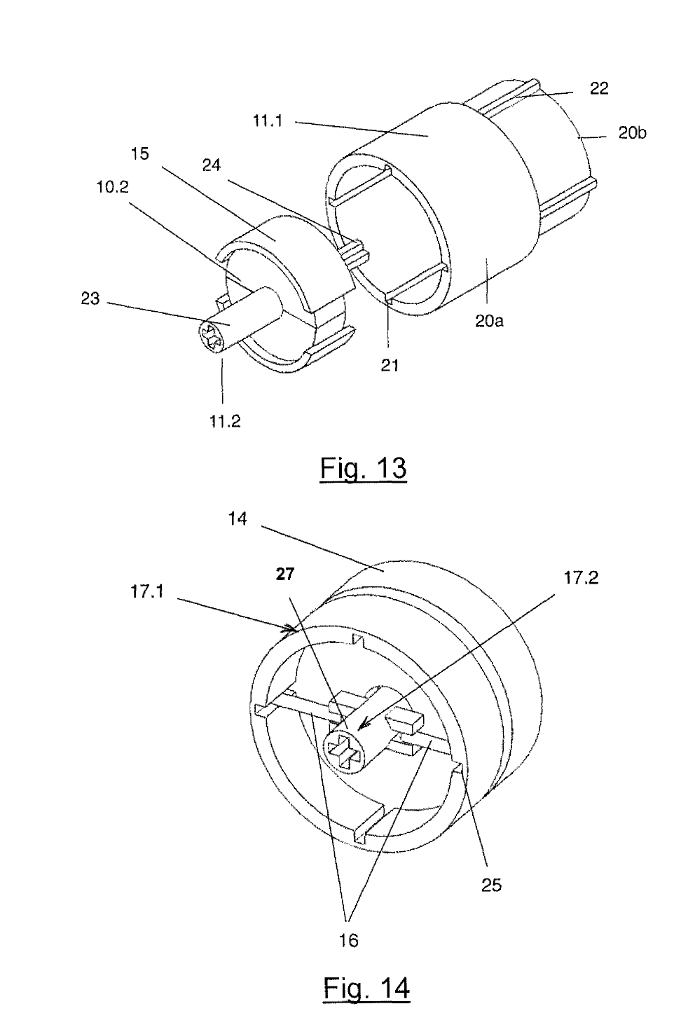

Ferromagnetic elements 15 can advantageously be provided around the magnets 10.2 (FIGS. 12 and 13) to modify the trend of the field lines from the radial to the axial trend, to maximize the efficiency of the magnetic interaction.

The energy recovery system comprises two elastic elements 16 acting between the two, external 17.1 and internal 17.2 counter-rotating outlets of the gearmotor.

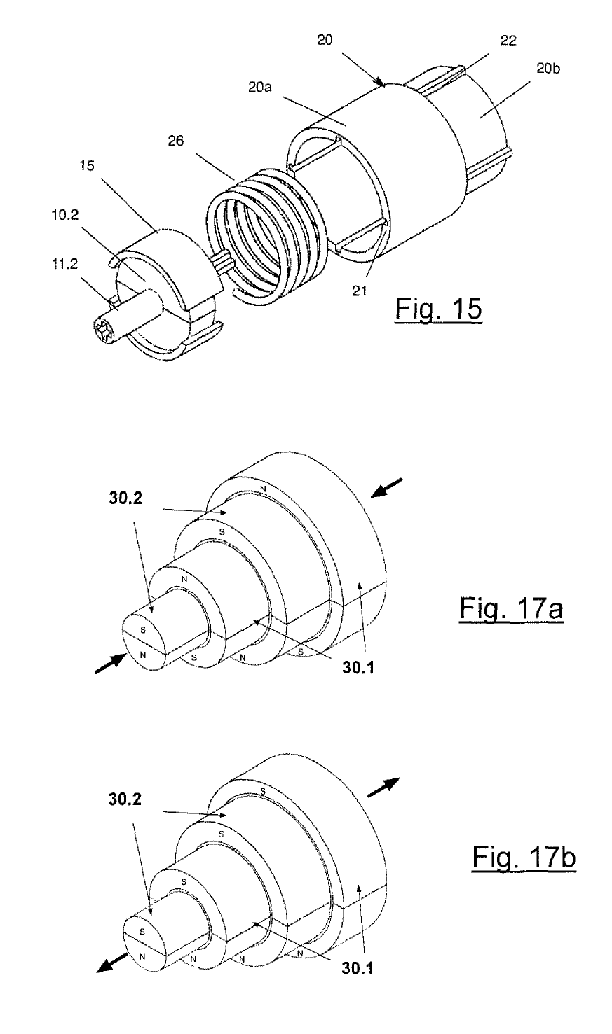

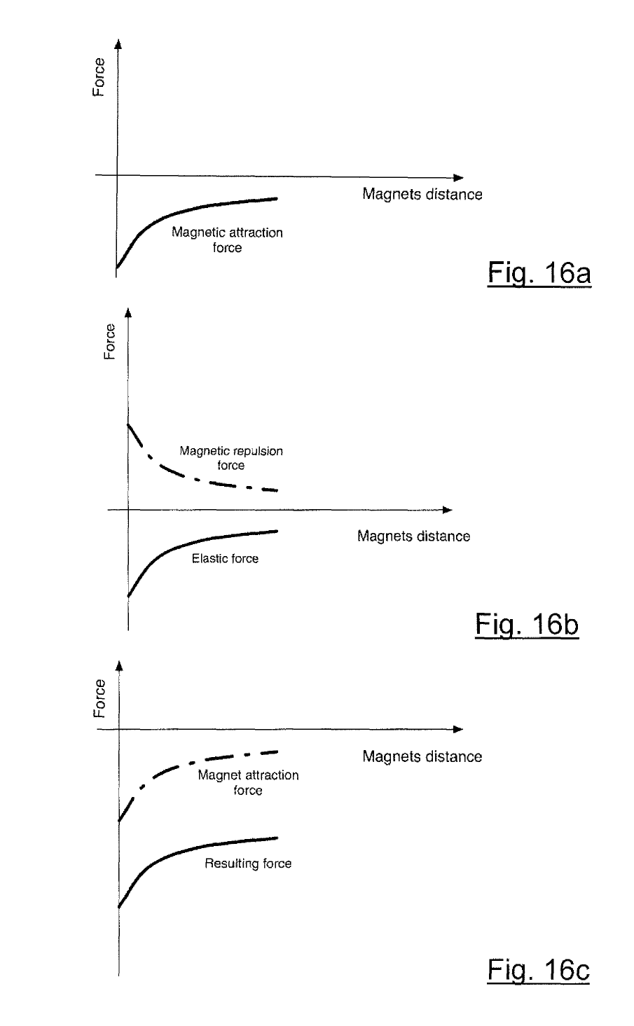

As shown in FIG. 15, further elastic elements 26 are advantageously inserted between consecutive magnets with a view to:
modifying the output force, making the trend similar to that of natural actuators (muscles), as shown graphically, as an example, in FIG. 6a,b,c. In the first of the graphs shown therein, the trend of the force between the magnets (in an attractive configuration) as a function of their position can be seen. The second shows the force generated by an elastic system, while the third shows the resultant force as a function of the distance between the magnets;
stabilizing the actuator in generic configurations. For instance, the configurations of repulsion can be balanced so as to simulate the relaxation of the muscle and make it function only in the condition of attraction. In this way, it is also possible to maximise the attraction force, which results as the sum of the magnetic interactions and of the elastic forces. FIG. 16a shows the trend of the attraction forces of the magnets without the presence of elastic elements. To balance the magnetic interaction in a configuration of repulsion the elastic system must be made so as to provide an attraction force that opposes the actions of magnetic repulsion. Said force, the trend of which is shown in FIG. 16b, is substantially equal to that of magnetic attraction. FIG. 16c shows the trend of the force, in a attraction configuration, that is increased by the addition of the elastic elements 26. This solution is particularly useful if we wish to obtain a unidirectional actuator.

The magnetic actuator of linear type according to the invention, such as the one shown in FIGS. 10-15, can also be made in a telescoping configuration. As shown in FIG. 17a) and b), in this case tubular or ring-shaped magnets 30.1, 30.2 are used so that they can enter coaxially one inside the other. Here again, rotating the magnets of the first set in relation to those of the second set makes it possible to obtain as output an axial attraction force (FIG. 17a) or an axial repulsion force (FIG. 17b). The structure of the actuator is deducible, in a manner that is obvious to a person skilled in the art, from the one described in relation to FIGS. 10-15 and is not repeated here for the sake of simplicity. This approach enables the stroke to be increased without changing the axial dimensions by comparison with the previous case.

The magnetic actuator according to the invention enables all the advantages typical of the single actuators of known type to be achieved. It allows a given orientation of the magnets to be converted into an output force, thus enabling the force to be controlled as in pneumatic actuation, but with a greater efficiency. In addition, the lack of hydraulic losses and the opportunity for energy recovery guarantee a performance closely resembling that of the servo-assisted motor needed for actuation. The forces obtainable are very high with respect to direct actuation with Lorentz forces, while retaining a total reversibility. Reversibility is superior to that achievable in the case of pneumatic actuation, which suffers from the presence of friction, which is absent in the case of the transmission of forces through magnetic interactions. Finally, a greater reversibility can be obtained than in the case of actuation with gearmotors.

By comparison with the gearmotor alone, the presence of the permanent magnets entails an increase in the weight of the actuator with a consequent reduction in the specific power delivered. On the other hand, by comparison with direct actuation, using either Lorentz force or variable-reluctance configurations, because of the low performance and low speeds typical of these types of actuation, the specific power output offered by the proposed solution is better. Finally, even with respect to the hydraulic solution, characterised by a modest performance and heavy additional components, the specific power delivered is greater.

Based on the above considerations it is evident that it is convenient to use the actuator according to the invention in all cases in which there is a need for adaptability and high performance, the sector of robotics being the most representative case.

1. A magnetic actuator with an adaptive type of actuation comprising
a set of permanent magnets comprising at least one first set of magnets and at least one second set of magnets spatially arranged so as to be able to interact magnetically with one another;
means for orienting the magnets of one set in relation to the magnets of the other set to vary the interaction between them;
potential energy storage means connected to the two sets of magnets to recover energy needed to orient the magnets,
and elastic means arranged between said at least one first set of magnets and said at least one second set of magnets to regulate a force resulting from said interaction.

2. The magnetic actuator according to claim 1, wherein said sets of magnets are arranged inside supporting elements made of a ferromagnetic material.

3. The magnetic actuator according to claim 1, wherein said potential energy storage means comprise elastic means.

4. The magnetic actuator according to claim 1, wherein the magnets forming said at least one first set of magnets and said at least one second set of magnets are diametrically magnetized, substantially cylindrical bodies aligned along their central axis and parallel to one another, the magnets of said first set alternating in said axial alignment with those of said second set and wherein the magnetic actuator further comprises drive means connected to the magnets of at least one of said sets in order to vary their relative orientation so as to shift from a configuration of mutual attraction between the magnets of said first and second sets to a configuration of mutual repulsion and vice versa, said potential energy storage means being installed between said two sets of magnets.

5. The magnetic actuator according to claim 4, wherein said means for orienting the magnets of one set in relation to those of the other set comprise a motor with a gearmotor with two counter-rotating drive outlets to which said two sets are respectively connected.

6. The magnetic actuator according to claim 5, wherein each magnet of said first set of magnets is fitted inside a respective tubular body, each tubular body having a portion axially engage able in a non-pivotal manner inside a corresponding portion of an adjacent tubular body to form a first alignment of tubular bodies connected to one of said counter-rotating drive outlets of said gearmotor, each tubular body being mounted pivotally on a hollow pin extending axially from one side of each magnet of said second set of magnets, which are pivotally contained inside said tubular bodies and integrally connected for rotation by means of said hollow pins and corresponding appendages non-pivotally engaging inside the cavities of adjacent hollow pins of magnets of said second set so to form a second alignment of magnets of said second set connected to the other of said counter-rotating outlets of said gearmotor.

7. The magnetic actuator according to claim 6, wherein the magnets of said first and second sets are at least partially provided laterally with a cover made of ferromagnetic material.

8. The magnetic actuator according to claim 6, wherein each of said tubular bodies comprises two coaxial portions of different diameter, the portion of narrower diameter having an external diameter such as to be able to engage inside the portion of wider diameter of an adjacent tubular body, axial grooves being formed on the inside of the portion of wider diameter and corresponding axial ribs being formed on the outside of said portion of narrower diameter for slidingly engaging in said internal axial grooves.

9. The magnetic actuator according to claim 4, wherein said potential energy storage means are elastic means arranged between the two counter-rotating outlets of said gearmotor.

10. The magnetic actuator according to claim 4, wherein second elastic means for regulating the interaction force are provided axially between the magnets of said first set and the magnets of said second set.

11. The magnetic actuator according to claim 1,
wherein said at least one first set of magnets and said at least one second set of magnets each comprises at least one pair of diametrically magnetized permanent magnets integrally attached to one another, said pairs of permanent magnets lying on parallel planes failing any mutual interaction, and presenting their respective magnets aligned in two rows,
wherein drive means are associated with each pair to vary the orientation of at least one of the two magnets of the pair so as to shift from a neutral configuration between the adjacent magnets of at least one of the two rows to a configuration of mutual attraction or repulsion and vice versa, the magnets of each pair being connected together by said potential energy storage means,
and wherein flexible connection means are provided between the consecutive pairs in the magnet alignment direction.

12. The magnetic actuator according to claim 11, wherein each pair of magnets is contained inside a structure of ferromagnetic material defining two polar expansions.

13. The magnetic actuator according to claim 11, wherein said potential energy storage means comprises a pair of preloaded parallel springs connecting the two magnets of each pair.

14. The magnetic actuator according to claim 11, wherein said flexible connection means constitute the elastic means for regulating the force of mutual interaction between each pair of magnets.

15. The magnetic actuator according to claim 1, wherein the magnets forming said at least one first set of magnets and said at least one second set of magnets are substantially tubular or ring-shaped bodies arranged coaxially in a telescoping configuration.
